(19) United States
(12) Patent Application Publication
(10) Pub. No.: US 2016/0302271 A1
(43) Pub. Date: Oct. 13, 2016

(54) Power Conserving Method for Electric Lighting Supply

(71) Applicants: Clinton O. Fruitman, Chandler, AZ (US); Earl D. Halberg, Scottsdale, AZ (US); Kenneth Sweinheart, Gig Harbor, WA (US)

(72) Inventors: Clinton O. Fruitman, Chandler, AZ (US); Earl D. Halberg, Scottsdale, AZ (US); Kenneth Sweinheart, Gig Harbor, WA (US)

(21) Appl. No.: 14/684,076

(22) Filed: Apr. 10, 2015

(51) Int. Cl. H05B 33/08; H05B 37/02

(52) U.S. Cl. CPC H05B 33/0815; H05B 33/0854; H05B 33/0884; H05B 37/0227; H05B 37/0218

(57) ABSTRACT

A method of reducing lighting energy by applying pulsed power cycle control to fast response lamps such as LEDs in a way that eliminates perceptible flicker while producing measureable and perceptible brightness equal to that of a steady current applied to similar lamps.

### CROSS-REFERENCE TO RELATED APPLICATIONS

This application is related to U.S. Provisional Patent Application Ser. No. 61/977,684, filed Apr. 10, 2014, entitled ‘Power Conserving Method For Electric Lighting Supply’, the disclosure of which application is incorporated herein by reference.

### BACKGROUND

In the method of operating AC and DC lamps of various types, continuous current is usually applied for maximum brightness. When current is diminished by either reducing voltage or chopping the pulses to a reduced duty cycle, lamp output proportionally dims until the power is no longer sufficient to output light. Dimming is a traditional way of conserving energy at the expense of useable lumen output.

Compared to electronic sensors, human vision has a relatively slow perceptibility to light intensity variations. Because of this, movie frames traveling across a shutter at speeds of 28 frames per second or greater seem to be flicker free. Academic and commercial attempts have been made to flicker lights in a fashion that seeks to reduce energy consumption while minimizing the noticeability of flicker. Unfortunately, these efforts invariably produce a dimming effect on the lumen output even with high speed flickered lamps. Also, flickering can produce psychotic effects and the 60 Hz AC of fluorescent lamps has been proven to be fatiguing.

With the advent of both analog and digital pulse width modulated power supplies and LED lamps, work has been performed to reduce lighting energy by controlling the duty cycle of the pulses as low as 70% in the 7 Hz to 1000 Hz range. However, investigators claim that illumination intensity is not easy to observe in these regions of control. In fact, human vision still averages down flickered light intensity even at many higher frequencies demonstrating less brightness. Physical measurement of the light output in these regions is also dimmer. From a functional point of view, light intensity dimming saves energy but reduces human perception of light in operations under street lighting, operation of tools, etc. Flicker and light dimness are enemies of effective vision.

Notwithstanding the current technology, a need for system that maximizes useable light output and minimizes energy input exists, in a way that a flicker free light is both perceptually and measurably as bright as the same system would produce when supplied with steady state current.

### SUMMARY

The present invention satisfies the need to maximize useable light output and minimize energy input by applying pulse frequency ranges with duty on—duty off cycle times to fast response lamps, such as LEDs (light emitting diodes), in a way that flicker free light is both perceptually and measurably as bright as the same lamps will produce when supplied with steady state current. This is possible due to the high speed nature of solid state devices allowing for very rapid and complete on/off pulsed activation without degradation of the devices.

An efficient and preferred embodiment pulses LED lights at fixed frequencies in the 75 KHz to 300+KHz range with the maximum duty off cycle times that still allows for maximum perceived brightness. When lamp pulse current is driven by a microprocessor regulated pulse width modulator, and current and lux sensors provide feedback to the microprocessor, power and light output can quickly be optimized through software logic.

The pulse width modulator can be either analog or digital. In a preferred embodiment MCU (micro controller unit) digital circuitry is used to drive the LED lamps with auto-optimizing devices and software that quickly tune the frequency and duty cycle for maximum brightness at minimum power (illustrated in FIG. 4 and FIG. 7).

A further advantage of this embodiment is the collection of data useful in projecting power consumption and battery life for any given set of frequencies and duty cycles. The MCU control applied here can also provide Low V battery protection, real time clock w/dusk to dawn or duration timer control, and light sensor triggering for on/off activation and dimming control. MCU control also enables central or local control of the lamps.

One embodiment comprises a wireless module for remote programming control.

Another embodiment comprises an IR sensing module for motion sensing control.

In another preferred embodiment, an embedded microprocessor in modular designed circuit platform is used as the core controller of the digital system that controls the frequency and duty cycle, with software that determines and outputs performance data such as brightness, power consumption, remaining battery life, and shutoff features that dim or turn off the lamp when the safety level of a battery's depletion has been reached (illustrated in FIG. 5).

In another preferred embodiment software controls the initial startup and final off time for a soft incremental activation and deactivation of the lighting system in a ramping fashion to eliminate surged power loadings (illustrated in FIG. 6). This in turn reduces or eliminates electric company fees for sudden and frequent changes in power consumption of line powered systems. Eliminating power surges also prolongs battery life.

In still another preferred embodiment, this invention provides a method of optimizing the power input for LEDs lamps or other fast response lamps outputs comprising the steps of: powering the lamps with a pulsed current; controlling duty on and duty off cycles of the pulsed current such that humanly perceptible light appears at maximum brightness with reduced power compared to similar lamps at the same maximum brightness powered with steady current; wherein the duty on cycle ranges between 1% and 99%; controlling pulse frequencies of the pulsed current to exceed 1000 Hz, such that the pulse frequencies are sufficient for human perception not to average down the perceived brightness due to the duty off cycle of the pulse; wherein the pulse frequencies exceeding 1000 Hz are sufficient that commonly available LUX meters do not average down measured light intensity due to the duty off cycle of the pulse. Also, it provides driving circuitry that facilitates the pulsed current, which is either analog or digital. In addition, the driving circuitry is governed by a programmable microprocessor unit. Additionally, it provides a light intensity measuring device, and/or a voltage measuring device, and/or an amperage measuring device.

In yet another preferred embodiment, this invention provides a method for optimizing light output vs. power consumption of a lamp system, as determined by feedback from measuring devices, the method, comprising the step of: providing at least one software enhanced computer processor; monitoring, with the at least one computer processor, battery life of the lamp system; optimizing, with the at least one computer processor, light output vs. power consumption of the lamp system; and extending the battery life of the lamp system from system startup through system shut off, with the at least one computer processor, for low voltage battery protection. Still, it provides a lamp system with a wireless module; and programming the wireless module from remote devices, through the at least one computer processor. Further, it provides controlling and managing the lamp system with a remote device. Furthermore, it provides integrating an infrared sensor into the lamp system to provide on/off control. Moreover, it provides integrating at least one light intensity sensor into the lamp system to provide brightness control. Still yet, it provides integrating at least one ambient light sensor into the lamp system to provide on/off control. Also, it provides integrating at least one ambient light sensor into the lamp system to provide brightness control. Additionally, it provides wherein the optimizing provides an extended battery life of at least 10% of a battery powering the lamp system. In addition, it provides for lower power consumption than required for continuous current powering of the lamp system. Further, it provides controlling dimmed light output with very short duty on cycle percentages of 1% to 5%. Moreover, it provides optimizing provides greatly extended battery life, up to 600%, of the LED lamp system. Furthermore, it provides wherein the lamp system consumes as low as 0.0002% of the power required for continuous current powering. Also, it provides wherein the pulse frequency is greater than 16 kHz. In addition, it provides wherein the pulse frequency is greater than 2 kHz. Still, it provides wherein the duty on cycle ranges between 35% and 70%. Additionally, it provides ramping the system startup and shutdown and eliminating surged power loading or unloading. In yet an additional preferred embodiment, setting the pulse frequency at 2 kHz and at 65% duty on cycle, battery life equaling 300% of the same lamps driven with continuous power is achievable.

### BRIEF DESCRIPTION OF THE DRAWINGS

FIG. 1 illustrates a typical square wave generated by a Pulse Width Modulator demonstrating on duty cycle (a), off duty cycle (b), cycle period (c), voltage (d) and frequency (e).

FIG. 2 illustrates a scheme with a pulse generator used to power single LED lamps (a), Banks of LED lamps (b) and multiple LED lamps (c), with the lamp power being supplied by source (d).

FIG. 3 illustrates actual data measured 25 feet from a solar/battery operated 4×100 W LED lamp tower driven with an analog pulse generator.

FIG. 4 illustrates flow chart logic for brightness/current auto-calibrating/optimizing software with inputs from voltage, current and light sensors.

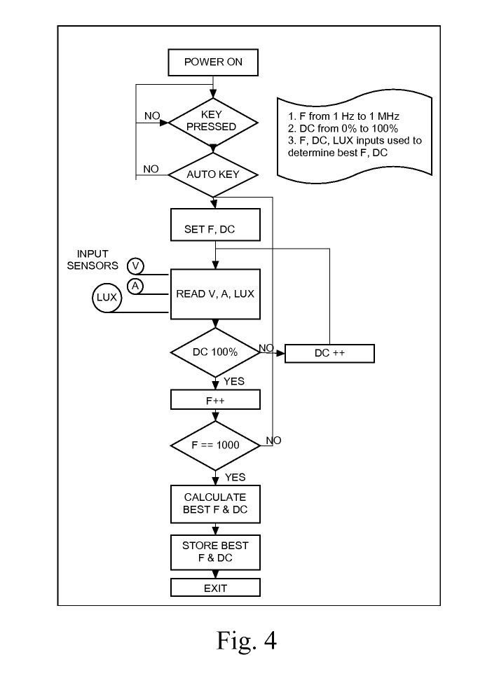

FIG. 5 illustrates flow chart logic of battery life protection software with voltage sensor input.

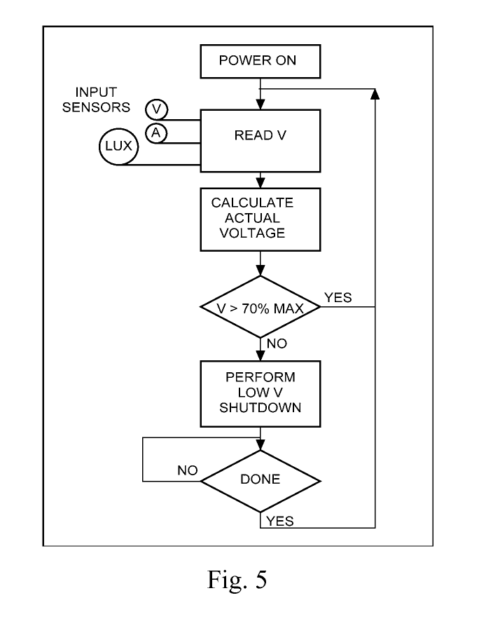

FIG. 6 illustrates flow chart logic of soft incremental ramp up and ramp down control software to eliminate surges.

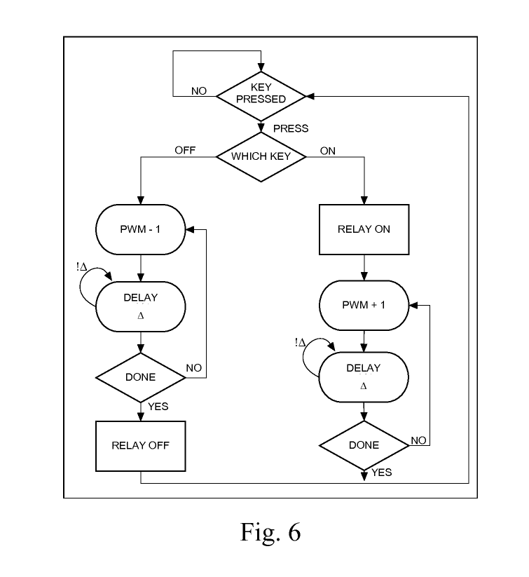

FIG. 7 illustrates a scheme for a digitally driven and controlled LED lamp set with pulse control programming capability, and multiple input/output functions.

### DETAILED DESCRIPTION

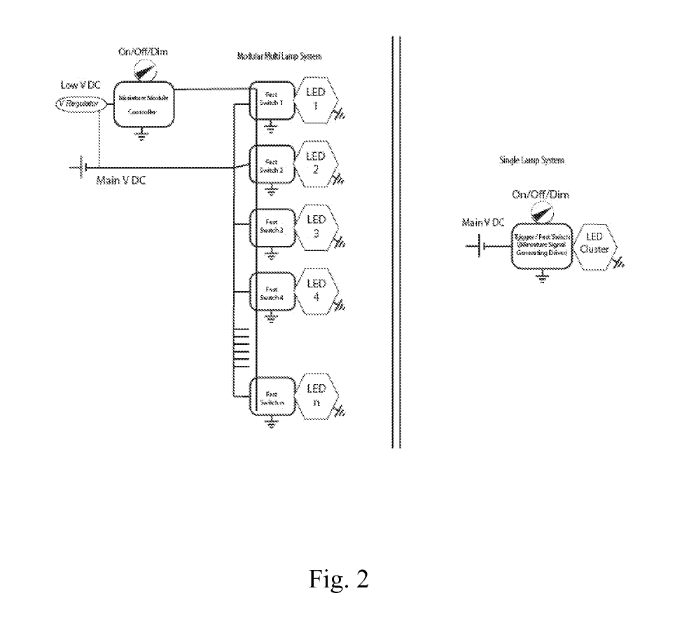

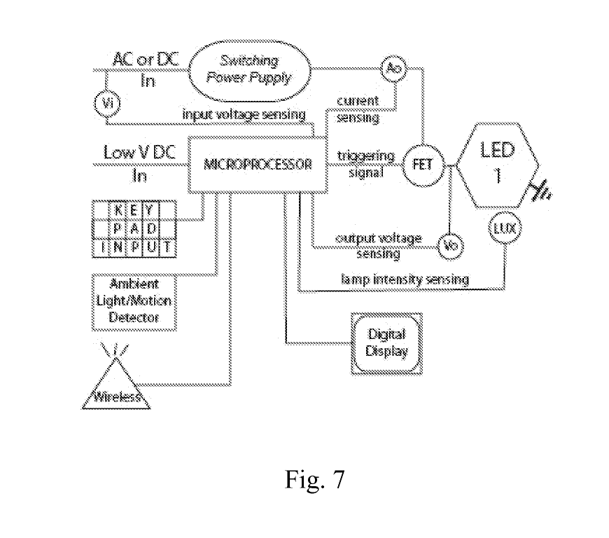

In a preferred embodiment of the present invention, a high frequency pulse width modulator (PWM) is wired to a lamp trigger such as a typical transistor as illustrated in FIG. 2 and FIG. 7. In a conventional fashion, the transistor acts as a switch to turn on single or multiple lamps when the base of the transistor receives a duty on signal from the PWM and blocks power from source to the lamp in FIG. 2 (d) when the duty on signal stops.

LED lamps and other fast acting lamps can flash on and off very quickly without the hysteresis effects of heating and cooling, which in other lighting devices that might be pulsed, would cause perceptual averaging of the light intensity resulting in dimming.

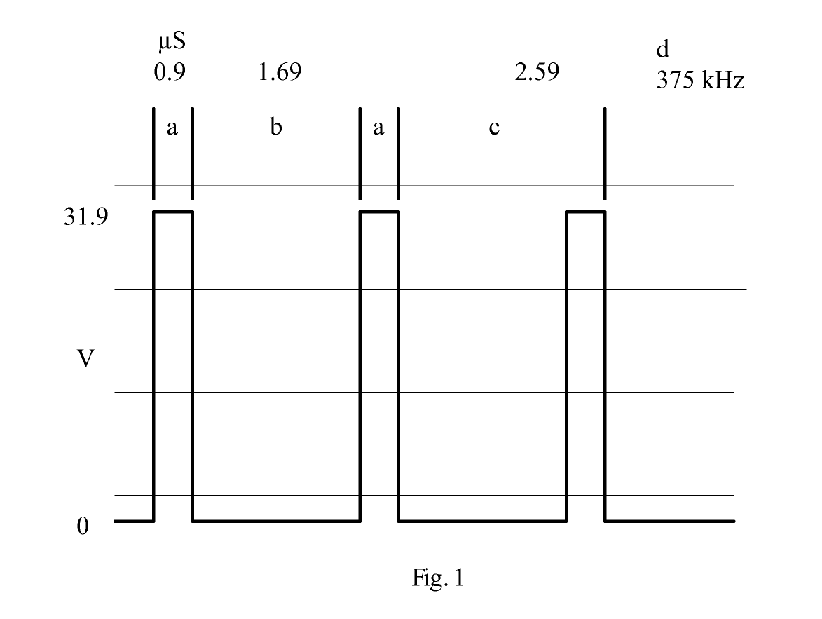

The LED or other fast acting lamps are driven at frequencies of 1 Hz to hundreds of thousands of Hz. The duty cycle percentage (D) of the period in FIG. 1(c) is set between 1% and 100%.

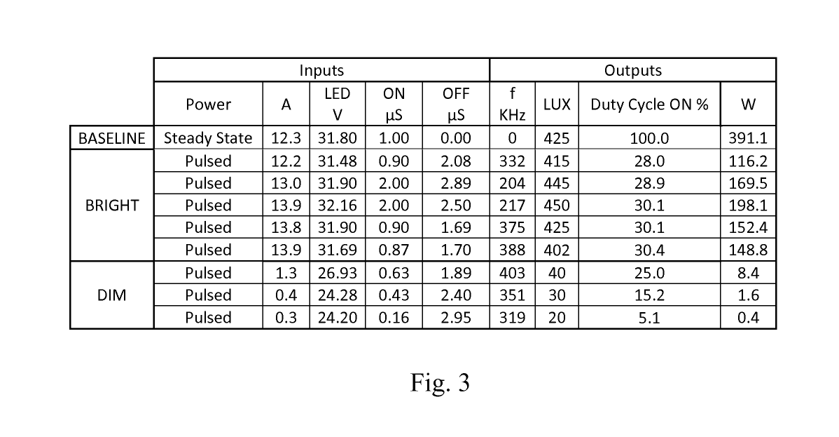

Light output is measured with an instrument, such as a LUX meter, and optimized for maximum light output sustained by minimum power input as demonstrated in the preferred embodiments of FIG. 3 and FIG. 7.

Wattage is calculated as W=A*V*D where V is the voltage drop across the lamp cluster terminal; A is the Amperage feeding the lamps; and D is the % on time of the duty cycle; or calculated as W=Aᵣₘₛ *V, where Aᵣₘₛ is Amperage_{root mean square}.

In the preferred embodiments of the present invention, illustrated on the chart of FIG. 3, it can be seen that at very high frequencies, low percentage duty cycles can effectively produce maximum apparent light output with significantly extended battery life or reduced energy consumption. Also illustrated in FIG. 3, at very low percentage duty cycles, dim but still usable lighting can be achieved with very large increases in battery life by virtue of very large decreases in power requirements, thus making possible a greatly extended battery illumination time when applied in emergency situations such as mining accidents.

Part of the crux of this invention is that the detection timing of human visual process, as well as the measurement speed of light with LUX meters, react too slow to average the light intensities produced by various high frequencies pulsed current duty cycles. At these frequencies, regardless of the duty cycle percentage, the LUX meter, and more importantly human physiology, sees the light as a constant illumination rather than dimmed. Thus pulse width dimming at these frequencies, while it actually exists, is not perceived much and can only be measured by the fastest light metering devices.

What is claimed is:

1. A method of optimizing the power input for LEDs lamps or other fast response lamps outputs comprising the steps of:
a. powering the lamps with a pulsed current;
b. controlling duty on and duty off cycles of the pulsed current such that humanly perceptible light appears at maximum brightness with reduced power compared to similar lamps at the same maximum brightness powered with steady current;
c. wherein the duty on cycle ranges between 1% and 99%;
d. controlling pulse frequencies of the pulsed current to exceed 1000 Hz, such that the pulse frequencies are sufficient for human perception not to average down the perceived brightness due to the duty off cycle of the pulse.

2. The method of claim 1, wherein driving circuitry facilitating the pulsed current is either analog or digital.

3. The method of claim 1, wherein the driving circuitry is governed by a programmable microprocessor unit.

4. The method of claim 1, further comprises providing a light intensity measuring device, and/or a voltage measuring device, and/or an amperage measuring device.

5. A method for optimizing light output vs. power consumption of a lamp system, as determined by feedback from measuring devices, the method, comprising the step of:
a. providing at least one software enhanced computer processor;
b. monitoring, with the at least one computer processor, battery life of the lamp system;
c. optimizing, with the at least one computer processor, light output vs. power consumption of the lamp system; and
d. extending the battery life of the lamp system from system startup through system shut off, with the at least one computer processor, for low voltage battery protection.

6. The method of claim 5, further comprises providing the lamp system with a wireless module; and programming the wireless module from remote devices, through the at least one computer processor.

7. The method of claim 5, further comprises controlling and managing the lamp system with a remote device.

8. The method of claim 5, further comprises integrating an infrared sensor into the lamp system to provide on/off control.

9. The method of claim 5, further comprises integrating at least one light intensity sensor into the lamp system to provide brightness control.

10. The method of claim 5, further comprising integrating at least one ambient light sensor into the lamp system to provide on/off control.

11. The method of claim 5, comprising integrating at least one ambient light sensor into the lamp system to provide brightness control.

12. The method of claim 5, wherein the optimizing provides an extended battery life of at least 10% of a battery powering the lamp system.

13. The method of claim 5, wherein the optimizing provides lower power consumption than required for continuous current powering of the lamp system.

14. The method of claim 5, further controlling dimmed light output with very short duty on cycle percentages of 1% to 5%.

15. The method of claim 5, wherein optimizing provides greatly extended battery life, up to 600%, of the LED lamp system.

16. The method of claim 5, wherein the lamp system consumes as low as 0.0002% of the power required for continuous current powering.

17. The method of claim 1, wherein the pulse frequency is greater than 16 kHz.

18. The method of claim 1, wherein the pulse frequency is greater than 2 kHz.

19. The method of claim 1, wherein the duty on cycle ranges between 35% and 70%.

20. The method of claim 1, further comprises ramping the system startup and shutdown and eliminating surged power loading or unloading.
